(19) United States
(12) Patent Application Publication
(10) Pub. No.: US 2025/0003389 A1
(43) Pub. Date: Jan. 2, 2025

(54) PORTABLE POWER GENERATION SYSTEM

(71) Applicant: POWERHOUSE WIND LIMITED, Dunedin (NZ)

(72) Inventors: Peter Forster Shaw, Lower Hutt (NZ); Richard George Arthur Butler, Dunedin (NZ); Timothy James Mepham, Dunedin (NZ); William Hugh Currie, Port Chalmers (NZ)

(73) Assignee: POWERHOUSE WIND LIMITED, Dunedin (NZ)

(21) Appl. No.: 18/709,266

(22) PCT Filed: Nov. 9, 2022
(86) PCT No.: PCT/NZ2022/050138

§ 371 Date: May 10, 2024

(30) Foreign Application Priority Data
Nov. 11, 2021 (NZ) 782234

(51) Int. Cl. F03D 13/20; E04H 12/34; F03D 13/10; H02S 10/12; H02S 10/40

(52) U.S. Cl. CPC F03D 13/201; E04H 12/345; F03D 13/112; H02S 10/12; H02S 10/40; F05B 2240/912

(57) ABSTRACT

A portable power generation system having a transportable structure can include a wind turbine having a tower mounted to the transportable structure configured to allow erection from within the transportable structure. It can also include a solar panel array pivotally connected to the structure that is expandable to an in use configuration in which the expanded solar panel is inclined to a side of the transportable structure.

### FIELD

This invention relates to a portable power generation system.

### BACKGROUND

Off-grid power generation systems are typically transported as separate components that are assembled and installed separately. A tower for a wind turbine typically has its own tower foundation and/or guy lines, solar panels are mounted on specific solar panel support structures and batteries/electrical components are housed within their own housing. This can make it difficult, time consuming and expensive to deploy and remove portable power generation systems.

### SUMMARY

In some configurations a portable power generation system can include: a transportable structure; a wind turbine; and a collapsible tower to support the wind turbine, wherein the tower is mounted to transportable structure and configured to allow erection from within the transportable structure.

In some configurations the tower can be pivotally connected to the transportable structure.

In some configurations the tower can have a pivotal connection part way along its length.

In some configurations the tower can be configured to allow telescopic extension.

In some configurations each tower section can be a tapering section dimensioned so that as one section is fully extended it is restrained within the lower section.

In some configurations the tower can be a continuous rigid structure.

In some configurations the structure can include a removable structural element that may be removed to facilitate tower erection and secured to provide structural support.

In some configurations the portable power generation system can include two wind turbines and two towers pivotally connected to the transportable structure.

In some configurations the portable power generation system can include a winch, cable and pulley system for erection of each tower.

In some configurations the portable power generation can include a ram for erecting each tower.

In some configurations the structure can include retractable wheels.

In some configurations the portable power generation system can include a power management system.

In some configurations the power management system can include a charge controller for charging rechargeable batteries.

In some configurations the power management system can include rechargeable batteries.

In some configurations the power management system can include an EV charge controller.

In some configurations the portable power generation system can include an electrolyser.

In some configurations the portable power generation system can include a water treatment device.

In some configurations the portable power generation system can include a linear actuator secured between the tower and the structure configured to erect the tower.

In some configurations each wind turbine can be a single bladed wind turbine.

In some configurations a method of erecting a wind turbine tower that is pivotally mounted to and within a structure can comprise pivoting the tower about its pivotal connection with the structure to an erected position.

In some configurations the wind turbine tower can have a pivotal connection along its length between an upper and a lower section with the lower section pivotally mounted to the structure, the method of erection comprising the steps of:
a. pivoting the upper tower section with respect to the lower tower section until they are aligned;
b. securing the upper and lower tower sections in their aligned configuration; and
c. pivoting the tower about its pivotal connection with the structure to an erected position.

In some configurations a structural section of the structure can be opened during tower erection and closed after tower erection.

In some configurations the wind turbine tower can have a pivotal connection along its length between an upper and a lower section with the lower section pivotally mounted to the structure, the method comprising the steps of:
a. partially lifting the distal end of the upper tower section until the upper section and turbine are supported by the structure;
b. pivoting the lower tower section with respect to the base and upper tower section until they are aligned;
c. securing the upper and lower tower sections in their aligned configuration; and
d. pivoting the tower about its pivotal connection with the structure to an erected position.

In some configurations the wind turbine tower can have telescopically connected upper and lower sections with the lower section pivotally mounted to the structure, the method comprising the steps of:
a. telescopically extending the upper section with respect to the lower section;
b. securing the upper and lower tower sections in their extended configuration; and
c. pivoting the tower about its pivotal connection with the structure to an erected position.

In some configurations a structural section of the structure can be opened during tower erection and closed after tower erection.

In some configurations the wind turbine tower can have telescopically connected upper and lower sections with the lower section pivotally mounted to the structure, the method comprising the steps of:
a. partially lifting the distal end of the lower tower section;
b. telescopically extending the upper section with respect to the lower section;
c. securing the upper and lower tower sections in their extended configuration; and
d. pivoting the tower about its pivotal connection with the structure to an erected position.

In some configurations the tower can be erected using a winch and cable.

In some configurations the tower can be erected using a linear actuator.

In some configurations the linear actuator can be a ram.

In some configurations a portable power generation system can include:
a. a transportable structure having a plurality of sides; and
b. a solar panel array having a first light capture area in a transportable configuration,
   wherein the solar panel array is pivotally connected at its upper edge to a hinged connection to the structure and is expandable to a second light capture area, greater than the first light capture area, to an in use configuration in which the expanded solar panel is inclined to a side of the transportable structure.

In some configurations the solar panel array can include a first panel and a second panel wherein the first and second panel slide with respect to each other to define the first and second light capture areas.

In some configurations the solar panel array can include a first panel pivotally connected to a second panel wherein the first and second panel rotate with respect to each other about the pivotal connection to define the first and second light capture areas.

In some configurations wheels can be provided on the distal edge of the solar panel array.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a portable power generation system according to one example;

FIG. 2 shows the initial position of a wind turbine and tower of the power generation system shown in FIG. 1 before a first method of erection;

FIG. 3 shows a partially lifted position of a wind turbine and tower of the power generation system from the position shown in FIG. 2;

FIG. 4 shows the extension of the wind turbine tower of the power generation system from the position shown in FIG. 3;

FIG. 5 shows the wind turbine tower fully erected from the position shown in FIG. 4;

FIG. 6 shows a second method of erecting a pivotally connected tower of a portable power generation system;

FIG. 7 shows a portable power generation system having a telescopically extending tower;

FIG. 8 shows extension of the telescopic tower of the portable power generation system shown in FIG. 7 prior to erection;

FIG. 9 shows a portable power generation system having a pair of pivoting wind turbine towers;

FIG. 10 shows a portable power generation system incorporating pivotally connected solar panels; and

FIG. 11 shows a portable power generation system incorporating sliding solar panels;

FIG. 12 shows a portable power generation system incorporating pivotally connected solar panels folding in a different manner to FIG. 10; and

FIG. 13 shows the solar panels of any one of FIGS. 10 to 12 when extended to an in use position.

### DETAILED DESCRIPTION

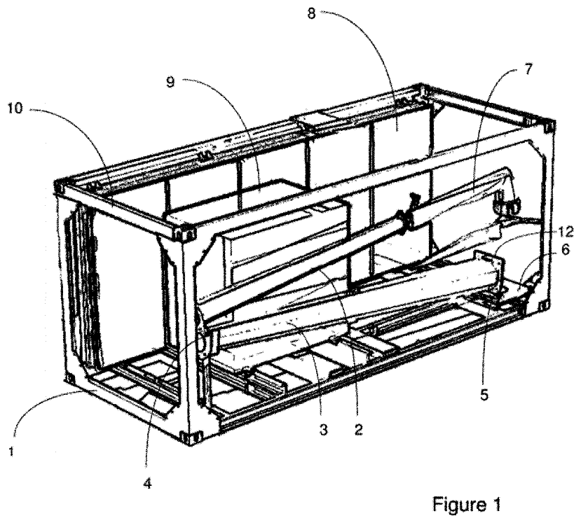

FIG. 1 illustrates a portable power generation system according to an example embodiment. A transportable structure 1 may have the same or similar dimensions to a standard 20 foot shipping container for ease of transportation by conventional means, such as a container transporting truck. The transportable structure 1 can contain a collapsible tower 2 & 3, wind turbine 7 mounted to the tower, solar panel assembly 8 and electrical system 9 or more or fewer components.

The tower includes a base section 2 with a pivotal connection 4 to a top tower section 3 and a pivotal connection 5 to a tower base 6. A wind turbine 7 is mounted to the top of top tower section 3. Although not essential it is advantageous if a single blade wind turbine is used as this has a compact profile for transportation and enables direct erection without the need to install wind turbine blades on site or otherwise constrain system design.

Solar panel assembly 8 is shown in its configuration for transportation. In one example configuration the assembly may be pivotally connected to the transportable structure 1 so that the panels may be easily pivoted out and deployed at a desired inclination to the structure.

The wind turbine 7 and solar panel assembly 8 may be pre-wired to an electrical system 9 so that no wiring is required when the portable power generation system is deployed on a site. The electrical system 9 may include:
Rechargeable batteries
Charge controller
Inverter to supply AC and/or DC power
Electric vehicle charger
V2H system
Communication equipment
Lighting

There may also be provided a water treatment system and/or an electrolyser to produce, store and provide hydrogen gas.

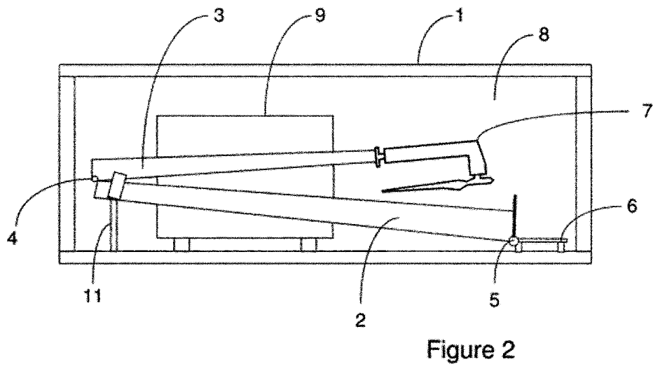

Referring now to FIGS. 2 to 5 a first method of tower erection will be described. FIG. 2 shows the tower in its collapsed state suitable for transportation. Tower base 6 is firmly secured to the portable structure 1 so that it may support the tower. The base of the tower 2 is pivotally connected to tower base 6 via pivotal connection 5 and the top tower section 3 is pivotally connected to the tower base section 2 via pivotal connection 4.

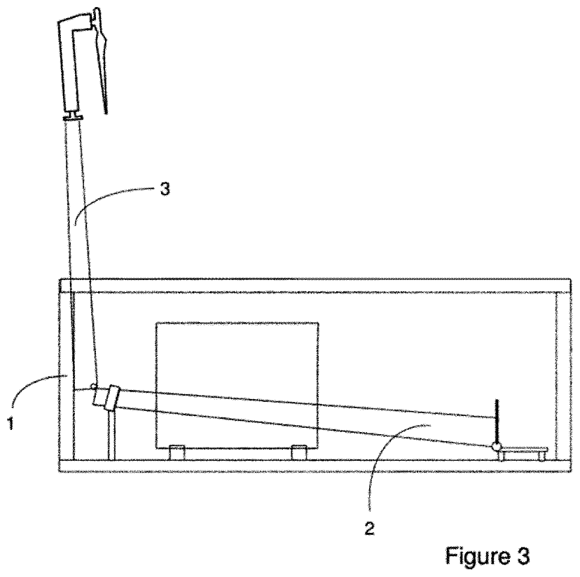

In a first erection step the tower may be partially lifted to the position shown in FIG. 3. This may be achieved using a winch and cables connected between suitable attachment points on the structure and tower or using rams or other conventional lifting arrangements. This is done in this example to so that the tower may be extended above structural element 10 that would otherwise inhibit pivoting of the tower sections.

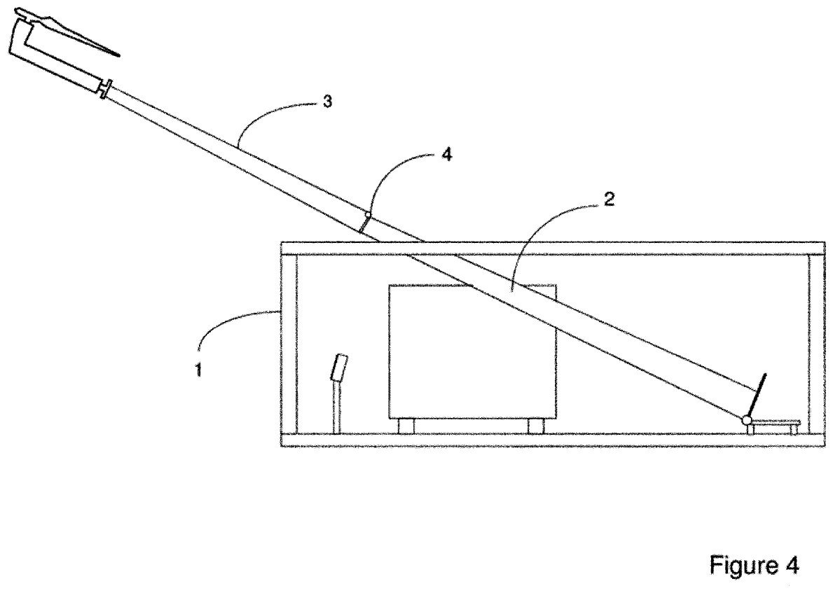

FIG. 4 shows a subsequent erection phase in which the top tower section 3 is rotated about pivotal connection 4 to the fully extended configuration shown. This may again be achieved using winches and cables or other means. The base tower section 2 and top tower section 3 may then be secured in position by means such as bolts through opposing plates on opposing ends of the base tower section 2 and top tower section 3.

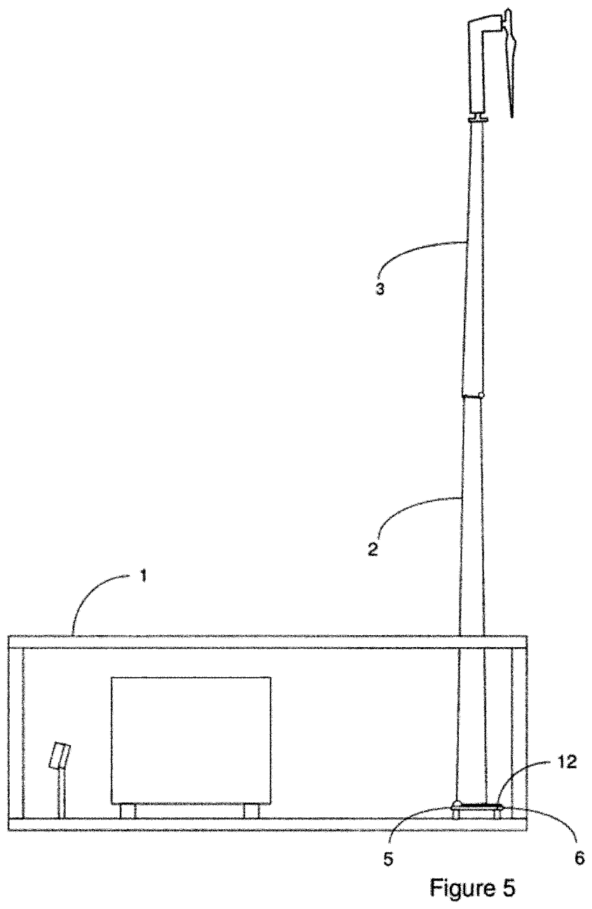

The tower may then be rotated about pivotal connection 5 to its fully erected position as shown in FIG. 5. This may again be achieved through use of a suitably positioned winch and cable or other suitable means. Once erected bolts may secure the tower base plate 12 to the tower base 6 to secure the tower in place. The tower may also be secured to the top of the transportable structure 1 or guy wires may be employed. Guy wires may be provided from the tower to fastening points on the top of the transportable structure 1 or to external fastening points, such as ground anchors. The portable structure 1 may also be secured to the ground via ground anchors etc.

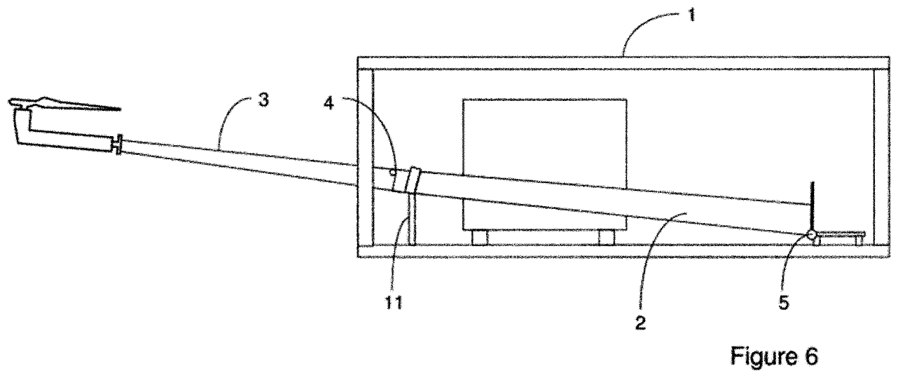

FIG. 6 illustrates a modified method of erecting the tower where a removable structural element 10 is provided as part of the portable structure 1 (see FIG. 1).

In this case removable structural element 10 may be removed, by removing bolts etc., before erection. In this case the top tower section 3 may be pivoted about pivotal connection 4 whilst the base tower section 2 remains supported by support 11. The top tower section 3 and base tower section 2 may then be secured together and the entire tower pivoted about pivotal connection 5 to erect the tower to the position shown in FIG. 5. This erection may again be performed using a winch and cable or other suitable means. Once the tower is erected the removable structural element 10 may be re-secured.

The tower is pivotally mounted to the transportable structure and configured to allow erection from within the transportable structure. The portable structure may thus be transported to a remote location via standard transportation, such as a container truck and a wind turbine may then be erected rapidly and easily simply by pivoting a tower into position and securing it. No ground preparation or wiring is required, just erection of the tower.

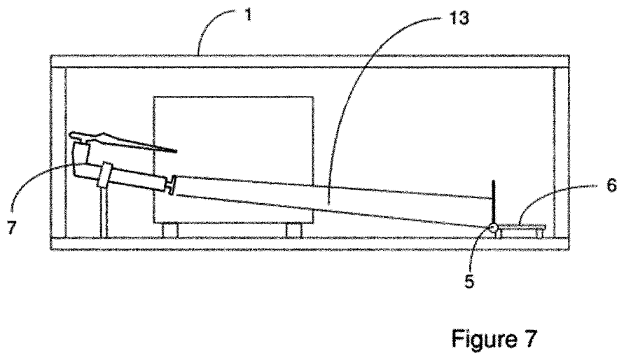

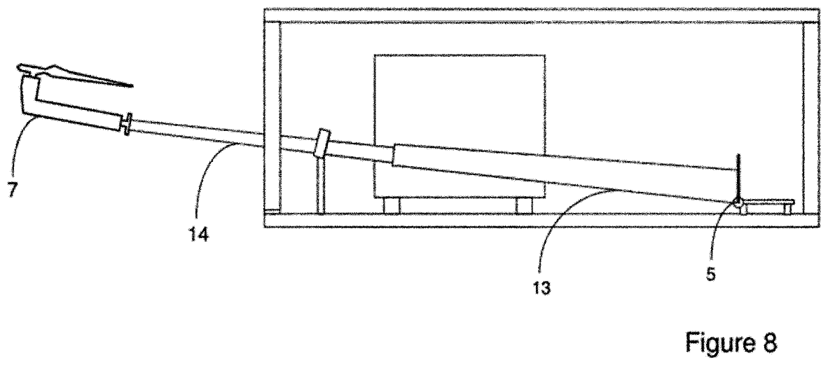

Referring to FIGS. 7 and 8 an example of a portable power system employing a telescoping tower is shown with like elements given like references to the previous examples. This example utilises the removable structural element 10, as per the example of FIG. 6. In this case the tower includes an upper tower section 14 and a base tower section 13. Each tower section can be a tapering section dimensioned so that as the upper section is fully extended it is restrained within the lower section. During transport the upper tower section is housed within the base tower section as shown in FIG. 7. Once delivered to a deployment site upper tower section 14 is telescopically extended with respect to base tower section 13 to the configuration shown in FIG. 8. The tower sections may be secured together when fully extended by means of screws or other suitable fasteners. The tower may then be pivoted about pivotal connection 5 to raise the tower to its erected position using a cable and winch secured between attachment points on the tower and portable structure 1. If a structural element is not employed then the tower may be partially lifted (as per FIG. 3) and extended before being erected as in the previous examples.

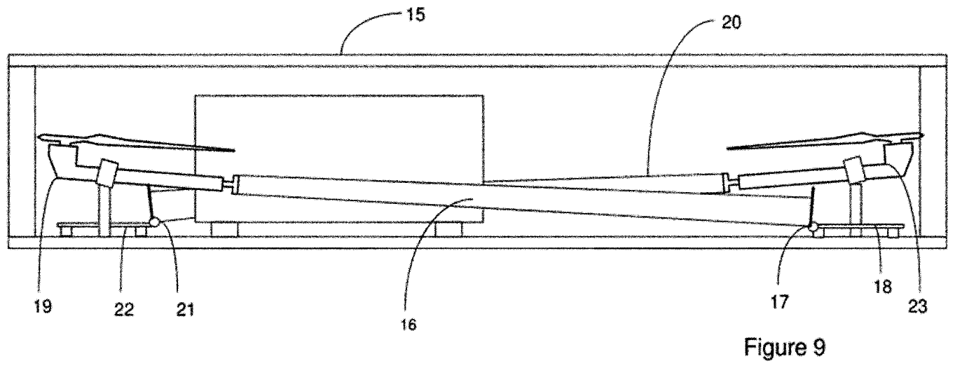

Referring now to FIG. 9 a further example portable power generation system is shown. In this example the portable structure 15 may have dimensions similar to a standard 40 foot shipping container. In this case it may be possible to utilise a single piece tower that is ready to be deployed simply by pivoting it into an erected position. It is also possible to employ in this and the previous examples two wind turbines. In this example a first tower 16 is pivotally mounted to a pivotal connection 17 of tower base 18 at one end and has a wind turbine 19 at the other end. A second tower 20 is pivotally mounted to a pivotal connection 21 of tower base 22 at one end and has a wind turbine 23 at the other end. The towers may be simply erected in one step using a cable and winch attached between attachment points on each tower and the structure or alternate means. This design offers extremely simple tower erection and lowering and provide twice the wind generating capacity.

The pivotal connections between the tower and tower base and between tower sections in the above examples may be a hinge or other suitable mechanical connections. Single blade wind turbines are preferred as they have a compact footprint in an installed configuration for transport. The structure may also be provided with retractable wheels to enable final positioning when delivered to a site.

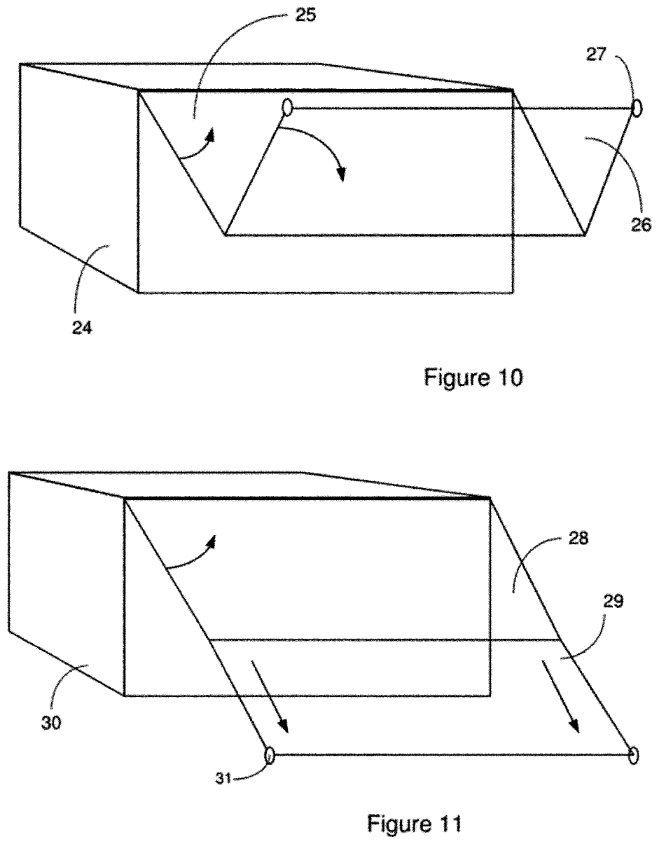

Referring now to FIGS. 10 and 11 different arrangements for solar panel assemblies that may deployed in any one of the previous examples will be described. In the example shown in FIG. 10 solar panels 25 and 26 may be folded together and secured to portable structure 24 to form a side wall during transportation (see the configuration of panel assembly 8 in FIG. 1). The outer face of panel 26 may be suitably protected to protect the panel assembly during transportation. When positioned at a deployment site, fasteners securing the panel assembly may be removed so that the panels may be deployed. Panel 25 may have a hinged connection to an upper edge of structure 24 and a hinged connection to panel 26. The panels may be pivoted with respect to the structure and each other as indicated by the arrows until the panels are in the same plane (with the panels locked in position by a locking mechanism) and angled to the structure at the required angle (typically about the latitude of installation although small variations will have little effect on efficiency and may simplify deployment). In this way the solar panels deploy to provide a solar capture area greater than area of the panels in transportation. Wheels 27 may also be provided on the distal edge of panel 26 to assist deployment (panel 26 could be unfolded first and then the hinged connection between panels raised until the panels are in the same plane).

In the example shown in FIG. 11 panel 28 has a hinged connection at its upper edge to an upper edge of structure 30. In this example panels 28 and 29 are mounted in a sliding arrangement with respect to each other as may be provided by a track mounted to panel 28 in which panel 29 slides. During transportation panels 28 and 29 may slide together in an overlapping relationship and secured to portable structure 30 to form a side wall during transportation (see the configuration of panel assembly 8 in FIG. 1). The outer face of panel 28 may be suitably protected to protect the panel assembly during transportation. When positioned at a deployment site fasteners securing the panel assembly may be removed so that the panels may be deployed. The panels may then be pivoted about the hinged connection to structure 27 as indicated by the curved arrow and then panel 29 may be slid out as indicated by the straight arrows to a fully deployed position. If wheels 31 are provided on the lower edge of panel 29 the panels may be walked out to a deployed position with the wheels supporting the panels as they are both rotated and extended.

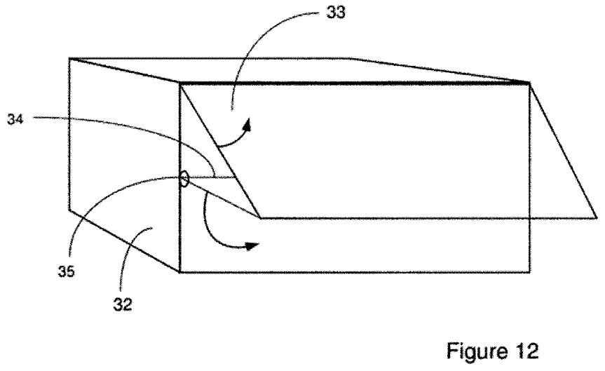

FIG. 12 shows a further example utilising pivotally connected solar panels in which panel 33 is pivotally connected to an upper edge of structure 32 and panel 34. In this case panel 34 is on the inside of panel 34 when forming a wall of the structure during transportation (as compared to FIG. 10 where lower panel 26 is on the outside). As indicated by the arrows in FIG. 12 when the panels are deployed panel 33 rotates upwards and panel 34 rotates downwards with wheels 35 at either end of the bottom edge of panel 34 supporting the lower edge when grounded.

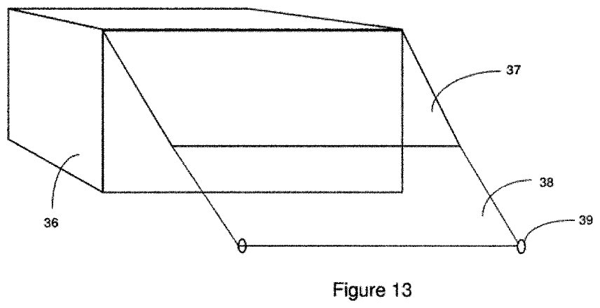

FIG. 13 shows the deployed configuration for any one of FIGS. 10 to 12 with panels 37 and 38 in the same plane and deployed at the desired angle to structure 36 with wheels 39 supporting the lower edge of the solar panel assembly.

There is thus provided a portable total energy supply solution with diversified generation capability. Deployment and removal is simple and requires no additional external works (i.e. tower foundation etc.).

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A portable power generation system including:
a transportable structure;
a wind turbine; and
a collapsible tower to support the wind turbine having a pivotal connection part way along its length;
wherein the tower is mounted to transportable structure and configured to allow erection from within the transportable structure.

2. A portable power generation system as claimed in claim 1 wherein the tower is pivotally connected to the transportable structure.

3-5. (canceled)

6. A portable power generation system as claimed in claim 2 wherein the structure includes a removable structural element that may be removed to facilitate tower erection and secured to provide structural support.

7. A portable power generation system as claimed in claim 1 including two wind turbines and two towers pivotally connected to the transportable structure.

8. A portable power generation system as claimed in claim 1 including a winch, cable and pulley system for erection of each tower.

9. A portable power generation system as claimed in claim 1 including a ram for erecting each tower.

10. A portable power generation system as claimed in claim 1 wherein the structure includes retractable wheels.

11. A portable power generation system as claimed in claim 1 including a power management system.

12. A portable power generation system as claimed in claim 11 wherein the power management system includes a charge controller for charging rechargeable batteries.

13. A portable power generation system as claimed in claim 12 wherein the power management system includes rechargeable batteries.

14. A portable power generation system as claimed in claim 11 wherein the power management system includes an EV charge controller.

15. A portable power generation system as claimed in claim 1 including an electrolyser.

16. A portable power generation system as claimed in claim 1 including a water treatment device.

17. A portable power generation system as claimed in claim 1 including a linear actuator secured between the tower and the structure configured to erect the tower.

18. A portable power generation system as claimed in claim 1 wherein each wind turbine is a single bladed wind turbine.

19-28. (canceled)

29. A portable power generation system as claimed in claim 1 wherein:
the transportable structure has a plurality of sides; and
a solar panel array is provided having a first light capture area in a transportable configuration,
wherein the solar panel array is pivotally connected at its upper edge to a hinged connection to the transportable structure and is expandable to have a second light capture area, greater than the first light capture area, in an in use configuration in which the expanded solar panel is inclined to a side of the transportable structure.

30. A portable power generation system as claimed in claim 29 wherein the solar panel array includes a first panel and a second panel wherein the first and second panel slide with respect to each other to define the first and second light capture areas.

31. A portable power generation system as claimed in claim 29 wherein the solar panel array includes a first panel pivotally connected to a second panel wherein the first and second panel rotate with respect to each other about the pivotal connection to define the first and second light capture areas.

32. A portable power generation system as claimed in claim 29 wherein wheels are provided on the distal edge of the solar panel array.
